(19) United States
(12) Patent Application Publication
(10) Pub. No.: US 2020/0174926 A1
(43) Pub. Date: Jun. 4, 2020

(54) APPARATUSES AND METHODS FOR ALLOCATING MEMORY IN A DATA CENTER

(71) Applicant: TELEFONAKTIEBOLAGET LM ERICSSON (PUBL), Stockholm (SE)

(72) Inventors: Amir ROOZBEH, Kista (SE); Mozhgan MAHLOO, Solna (SE)

(73) Assignee: TELEFONAKTIEBOLAGET LM ERICSSON (PUBL), Stockholm (ES)

(21) Appl. No.: 16/614,937

(22) PCT Filed: Jun. 22, 2017
(86) PCT No.: PCT/SE2017/050694

§ 371 Date: Nov. 19, 2019

(51) Int. Cl. G06F 12/06; G06F 12/10; G06F 9/50

(52) U.S. Cl. CPC G06F 12/0646; G06F 12/10; G06F 2209/501; G06F 2212/1016; G06F 2212/657; G06F 9/5016

(57) ABSTRACT

There is provided a method performed by a memory allocator, MA, and a MA, for allocating memory to an application on a logical server having a memory block allocated from at least one memory pool. In one action of the method, the MA 5 obtains performance characteristics associated with a first portion of the memory block and obtains performance characteristics associated with a second portion of the memory block. The MA further receives information associated with the application and selects one of the first portion and the second portion of the memory block for allocation of memory to the application, based on the received 0 information and at least one of the performance characteristics associated with the first portion of the memory block and the performance characteristics associated with the second portion of the memory block. An arrangement and methods performed therein, computer programs, computer program products and carriers are also provided.

### TECHNICAL FIELD

Embodiments herein relate to a memory allocator and methods performed therein for allocating memory. Furthermore, an arrangement and methods performed therein, computer programs, computer program products, and carriers are also provided herein. In particular, embodiments herein relate to a memory allocator for allocating memory to an application on a logical server.

### BACKGROUND

In traditional server architecture, a server is equipped with a fixed amount of hardware, such as processing units, memory units, input/output units, etc., connected via communication buses. The memory units provide physical memory, that is, physical memory available for the server, having a physical memory address space. A server Operating System (OS), however, works with a virtual memory address space, herein after denoted “OS virtual memory”, and therefore reference the physical memory by using virtual memory addresses. Virtual memory addresses are mapped to physical memory addresses by the memory management hardware. The OS's virtual memory addresses are assigned to any memory request, e.g., by applications (“Apps”) starting their execution on the server, and the OS keeps the mapping between application memory address space and OS virtual memory addresses through the Memory Management Unit (MMU). The MMU is located between, or is part of, the microprocessor and the Memory Management Controller (MMC). While the MMC's primary function is the translation of OS's virtual memory addresses into a physical memory location, the MMU's purpose is the translation of application virtual memory addresses into OS virtual memory addresses. FIG. 1 illustrates an exemplary virtual memory to physical memory mapping for two applications, App 1 and App 2, respectively, wherein the Apps virtual memory is mapped to OS virtual memory and from OS virtual memory to physical memory. Each application has its own virtual memory address space starting from 0, herein after denoted “App virtual memory”, and it is saved in a table mapping application virtual memory addresses to OS memory virtual addresses. FIG. 2 shows an exemplary table for address mapping. The figure illustrates that the App's virtual memory may be divided into parts, e.g. two parts, for App 1 address 0-100 and address 100-300, respectively, as exemplified in FIG. 2, which are mapped to different locations (addresses) in the OS virtual memory and the physical memory, respectively. In FIG. 1 only the mapping of the part having the lower address range of App 1 and App 2 is shown.

The OS is responsible for selecting the address range from the OS virtual memory to be allocated to each application. The task of fulfilling an allocation request from the application to OS consists of locating/finding an address range from OS virtual memory that is free, i.e. unused memory, with sufficient size and accessible to be used by applications. At any given time, some parts of the memory are in use, while some are free and thus available for future allocations.

### SUMMARY

Independently of the actual location in the physical memory unit(s), the server's OS considers the whole virtual memory address space, i.e., the OS virtual memory, as one large block of virtual memory. As illustrated in FIG. 1, the OS virtual memory has an address range starting at address zero and comprises continuous memory addresses up to the block's highest address, thus being determined by the size of the block, e.g., an address range 0-3000 as in FIG. 1.

This means that the OS cannot differentiate whether the physical memory of the server is composed of several memory units and, if so, whether the units comprise different memory types with distinct characteristics or not. This was not an issue for the servers up to now, however, with the introduction of new architecture design within the data centers, namely as “disaggregated architecture”, the current concepts of physical and virtual memory will change drastically. Disaggregating a memory unit from a processing unit, e.g., a Central Processing Unit (CPU), can cause degradation in the performance of applications, if it is not carefully addressed.

FIG. 3 shows a disaggregated architecture comprising several pools of functions such as pool(s) of CPUs, memories, storage nodes as well as NICs (Network Interface Cards), connecting through a very fast interconnect. This means that distinct and pre-configured servers as it is today, disappears in future data center architectures. Instead, hosts in form of micro servers, hereinafter called logical servers, are created dynamically and on-demand by combining a subset of available hardware of the pool(s) in the data center, or even within several geographically distinct data centers. During this creation, a block of memory is allocated to the logical server from one or more memory pools. The memory block is in the distributed hardware often divided into a number of, usually different sized, portions which may be comprised in different physical memory units of the one or more memory pools, i.e., one portion may be located in one memory unit, and another portion of the same memory block may be located in another memory unit. The memory block allocated to a logical server thus has a representation in form of a physical memory space, as well as a virtual memory space, i.e., the aforementioned OS virtual memory.

Having different memory pools, brings the possibility of having different memory types, with distinct characteristics and distances to the CPUs, impacting performance of logical servers and applications which are running on top of such system.

However, the mechanisms for selecting memory units and addresses in a legacy system have drawbacks when applied to a system having a distributed architecture, in worst cases resulting in sluggish behaviour servers and applications running thereon.

An object of embodiments herein is to provide an improved mechanism for memory allocation.

Another object of embodiments herein is to provide an improved mechanism for selection of a memory address range within an allocated memory block of a logical server for an application at initialization.

According to a first aspect, there is provided a method performed by a memory allocator (MA) for allocating memory to an application on a logical server having a memory block allocated from at least one memory pool. In one action of the method, the MA obtains performance characteristics associated with a first portion of the memory block and obtains performance characteristics associated with a second portion of the memory block. The MA further receives information associated with the application and selects one of the first portion and the second portion of the memory block for allocation of memory to the application, based on the received information and at least one of the performance characteristics associated with the first portion of the memory block and the performance characteristics associated with the second portion of the memory block.

According to a second aspect, there is provided a memory allocator (MA) for allocating memory to an application on a logical server having a memory block allocated from at least one memory pool. The MA is configured to obtain performance characteristics associated with a first portion of the memory block and obtain performance characteristics associated with a second portion of the memory block. The MA is further configured to receive information associated with the application and select one of the first portion and the second portion of the memory block for allocation of memory to the application, based on the received information and at least one of the performance characteristics associated with the first portion of the memory block and the performance characteristics associated with the second portion of the memory block.

According to a third aspect, there is provided a memory allocator (MA) for allocating memory to an application on a logical server having a memory block allocated from at least one memory pool. The memory allocator comprises a first obtaining module for obtaining performance characteristics associated with a first portion of the memory block and a second obtaining module for obtaining performance characteristics associated with a second portion of the memory block. The MA also comprises a receiving module for receiving information associated with the application and a selecting module for selecting one of the first portion and the second portion of the memory block for allocation of memory to the application, based on the received information and at least one of the performance characteristics associated with the first portion of the memory block and the performance characteristics associated with the second portion of the memory block.

According to a fourth aspect, there is provided a method for allocating memory to an application on a logical server having a memory block allocated from at least one memory pool. The method comprises receiving at an Operating System (OS) a request for memory space from an application. The OS sends information associated with the application to a Memory Allocator (MA). The MA receives the information associated with the application from the OS and selects one of a first portion and a second portion of the memory block for allocation of memory to the application, based on the information associated with the application and at least one of a performance characteristics associated with the first portion of the memory block and a performance characteristics associated with the second portion of the memory block.

According to a fifth aspect, there is provided an arrangement for allocating memory to an application on a logical server having a memory block allocated from at least one memory pool. The arrangement comprises an Operating system (OS) and a Memory Allocator (MA). The OS is configured to receive a request for memory space from an application. The OS is further configured to send information associated with the application to the MA. The MA of the arrangement is configured to receive information associated with the application from the OS and select one of a first portion and a second portion of the memory block for allocation of memory to the application, based on the information associated with the application and at least one of a performance characteristics associated with the first portion of the memory block and a performance characteristics associated with the second portion of the memory block.

According to a sixth aspect, there is provided a computer program comprising instructions, which when executed on at least one processor, cause the processor to perform the corresponding method according to the first aspect. According to a seventh aspect, there is provided a computer program comprising instructions, which when executed on at least one processor, cause the processor to perform the corresponding method according to the fourth aspect.

According to an eighth aspect, there is provided a computer program product comprising a computer-readable medium having stored there on a computer program of any of the sixth aspect and the seventh aspect.

According to a ninth aspects, there are provided a carrier comprising the computer program according to any of the sixth aspect and the seventh aspect. The carrier is one of an electronic signal, an optical signal, an electromagnetic signal, a magnetic signal, an electric signal, a radio signal, a microwave signal, or a computer-readable storage medium.

Disclosed herein are methods to improve the memory allocation of an application when initialized on a logical server. Embodiments herein may find particular use in data centers, having a distributed hardware architecture. The methods may for instance allow the logical server to allocate memory resources optimally for applications to optimize performance of both the logical server and the applications running on the logical server. Some embodiments herein may thus avoid the logical server becoming sluggish and enable that applications execute with sufficient speed, for example.

### BRIEF DESCRIPTION OF THE DRAWINGS

In the following, embodiments and exemplary aspects of the present disclosure will be described in more detail with reference to the drawings, in which:

FIG. 1 is a schematic example of mapping virtual memory to physical memory.

FIG. 2 shows exemplary memory address tables and mapping.

FIG. 3 is a schematic overview depicting a disaggregated hardware architecture.

FIG. 4 illustrates schematically an example of a mapping of physical resources to a logical server.

FIG. 5 is a flowchart depicting a method performed by a memory allocator according to a particular embodiment.

FIG. 6 illustrates schematically system components according to a particular embodiment.

FIG. 7 is a flowchart depicting methods performed by arrangements according to particular embodiments.

FIG. 8 illustrates schematically an arrangement according to a particular embodiment.

FIG. 9a depicts an exemplary MMC memory address table of the known art.

FIG. 9b depicts an exemplary MMC memory address table according to a particular embodiment.

FIG. 10 illustrates schematically a further arrangement according to a particular embodiment.

FIG. 11a illustrates schematically a memory allocator and means for implementing some particular embodiments of the methods herein.

FIG. 11b illustrates schematically an example of a computer program product comprising computer readable means according to certain embodiments.

FIG. 11c illustrates schematically a memory allocator comprising function modules/software modules for implementing particular embodiments.

FIG. 12a illustrates schematically an arrangement and means for implementing some particular embodiments of the methods herein.

FIG. 12b illustrates schematically an example of a computer program product comprising computer readable means according to certain embodiments.

FIG. 12c illustrates schematically an arrangement comprising function modules/software modules for implementing particular embodiments.

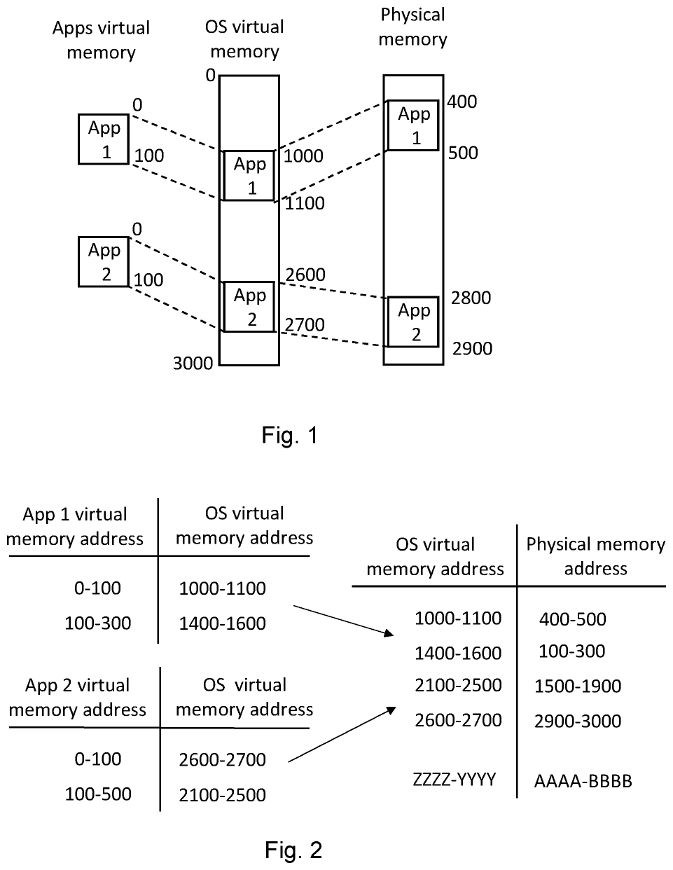

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

In the following description, explanations given with respect to one aspect of the present disclosure correspondingly apply to the other aspects.

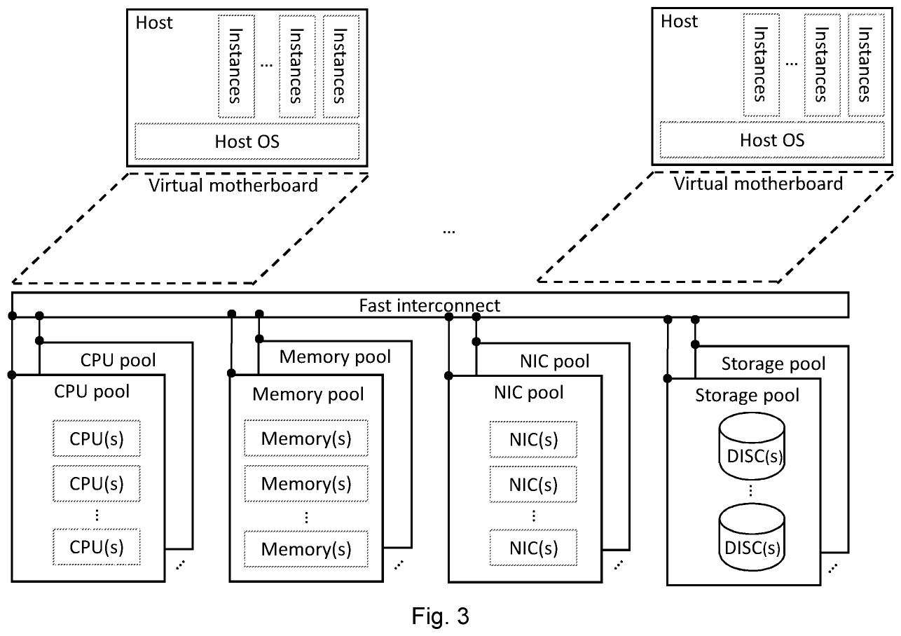

For better understanding of the proposed technology, FIG. 3 is described in more detail. The illustrated hardware disaggregated architecture comprises CPU pools, memory pools, NIC pools, and storage pools, which pools are shared between logical servers or hosts. Each pool can have none, one or more management units. For example, the CPU pool might contain one or more MMUs (not shown). The MMU is in charge of translating the application virtual memory addresses to the OS virtual memory addresses, and it is associated with the CPU, either by being implemented as part of the CPU, or as a separate circuit. The memory pool can have one or more MMCs (not shown) responsible for handling performance of the memory units, as well as managing physical memory addresses. It should be noted that, there might also be a limited amount of memory residing in the CPU pools to improve the performance of the whole system, which can be considered as a closest memory pool to the CPU(s). This local memory pool, has a high value due to its close proximity to the CPU(s) and it should be used efficiently.

NIC pools are used as the network interface for any of the components in the pools, i.e., CPUs, memory units, storage nodes that need external communication during their execution. Storage pools contain a number of storage nodes for storing the persistent data of the users. A fast interconnect connects the multiple resources.

On top of the above described hardware resources, thus comprising a hardware layer, there may be different logical servers (called “hosts” in FIG. 3), responsible for running various applications. Additionally, there may be a virtualization layer (not shown) on top of the hardware layer for separating the applications and the hardware.

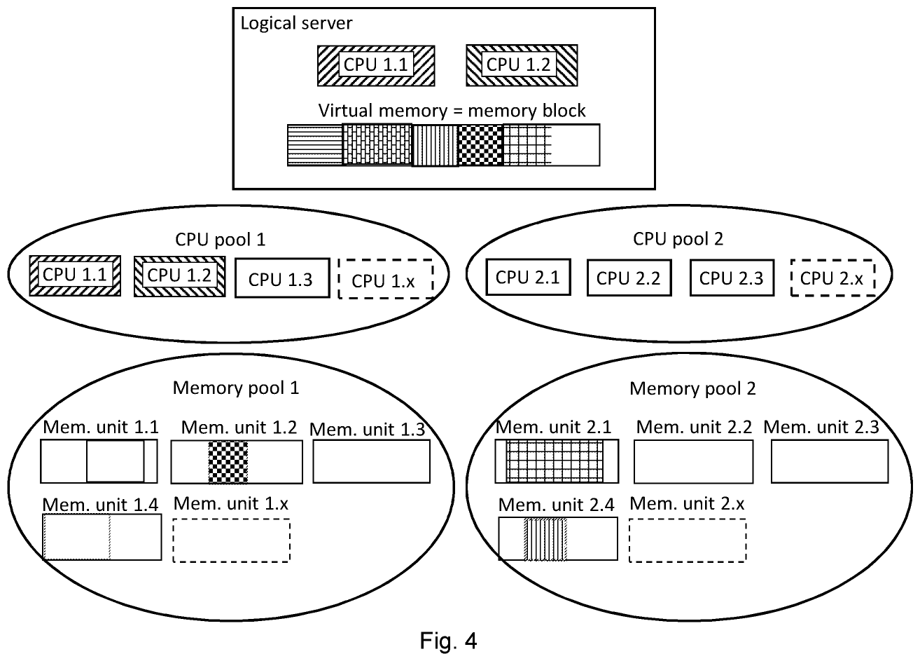

New data center hardware architectures rely on the principle of hardware resource disaggregation. The hardware disaggregation principle considers CPU, memory and network resources as individual and modular components. As described above, these resources tend to be organized in a pool based way, i.e., there is a pool of CPU units, a pool of memory units, and a pool of network interfaces. In this sense, a logical server is composed of a subset of units/resources within one or more pools. Applications run on top of logical servers which are instantiated on request. FIG. 4 illustrates an example of a mapping of physical resources to a logical server.

With respect to the memory pools in a disaggregated architecture, each memory pool can serve multiple logical servers, by providing dedicated memory slots from the pool to each server, and a single logical server can eventually consume memory resources from multiple memory pools.

As seen from FIG. 4, a logical server can have a number of CPUs, as well as a predefined unit volume of memory allocated to it. The underlying physical resources are hidden from the logical server in the way that it can only see a large block of virtual memory with continuous address space, which is herein referred to as a memory block. Due to the various characteristics of different memory pools, and the memory units, not all parts of virtual memory can provide the same performance to the applications running on top of them.

As exemplified by FIG. 4, a memory unit may comprise a portion of one or more memory blocks. By a portion of a memory block is herein meant a memory space having a consecutive range of memory addresses in a physical memory unit. A memory block allocated to a logical server may, thus, be divided into portions, which portions may be located in one or more, physical, memory units in the memory pool(s). Two, or more, portions of the same memory block may be located in the same memory unit and be separated from each other, i.e., the address ranges of the two or more portions are discontinued. Two, or more, portions of the same memory block in a memory unit may additionally or alternatively be directly adjacent to each other, i.e., the two or more portion have address ranges that are consecutive in the memory unit.

In the following a MA and a method performed thereby are briefly described. The MA is provided for allocating memory to an application on a logical server, which may be running in a data center. To the logical server, there is allocated a memory block from at least one memory pool. The allocation of the memory block may thus be from one or more memory unit(s) comprised in one or more memory pool(s). According to the method, the MA obtains performance characteristics associated with a first portion of the memory block and obtains performance characteristics associated with a second portion of the memory block. The MA further receives information associated with the application and selects one of the first portion and the second portion of the memory block for allocation of memory to the application, based on the received information and at least one of the performance characteristics associated with the first portion of the memory block and the performance characteristics associated with the second portion of the memory block.

The method performed by the MA provides several advantages. One possible advantage is that each application can be placed in the physical memory based on application requirement. Another possible advantage is better usage of memory pools. A further possible advantage is the improvement of application performance and speed up of the execution time, meaning that more tasks can be executed with less amounts of resources and in shorter time.

The performance characteristics can be said to be a measure of how well the portion of the memory block is performing, e.g. with respect to the connected CPU. Merely as an illustrative example, there may be one or more threshold values defined for different types of performance characteristics, wherein when a threshold value is met for a performance characteristic, the first portion of the memory block is performing satisfactorily and when the threshold value is not met, the first portion of the memory block is not performing satisfactorily. The definition of the threshold value defines what is satisfactorily, which may be a question for implementation. Merely as a non-limiting and illustrative example, the performance characteristic is delay, wherein when the threshold value is met, the delay is satisfactorily and when the threshold value is not met, the delay is too long, thus not satisfactorily. One possible reason for too long a delay may be that the first portion of the memory block is located relatively far from one or more CPU resources. In another non-limiting and illustrative example, the performance characteristics is how frequent the first portion of the memory block is accessed. It may be that the memory is of a type that is adapted for frequent access or that the first portion of the memory block is located relatively close to one or more CPU resources, wherein if the first portion of the memory block is not accessed very frequently, then the first portion of the memory block is not optimally used. Further, the memory pool(s) may comprise different types of memory, e.g. Solid-State Drive, SSD, Non-Volatile RAM, NVRAM, SDRAM, and flash type of memory, which generally provide different access times so that data that is accessed frequently may be stored in a memory type having shorter access time such as a SDRAM and data that is accessed less frequently may be placed in a memory type having longer access time such as a NVRAM. The choice of memory may be dependent on various parameters in addition to access time, e.g. short time storage, long time storage, cost, writability etc.

In some embodiments, the performance characteristics associated with the first and second portion of the memory block, which as an example are comprised in a first and second memory unit, respectively, may be defined by one or more of (i) access rate of the respectively first and second memory unit, (ii) occupancy percentage of the respectively first and second memory unit, (iii) physical distance between the respectively first and second memory unit and a CPU resource (of the CPU pool) comprised in the logical server, (iv) respectively first and second memory unit characteristics e.g. memory type, memory operation cost, memory access delay, and (v) connection link and traffic conditions between the respectively first and second memory units and CPUs comprised in the logical server.

The MA may in some embodiments obtain performance characteristics of portions of a memory block allocated to a logical server by monitoring the physical memory units of the memory block and/or other hardware associated with the logical server, e.g., CPUs, communication links between memory units and CPUs, etc. Alternatively, the MA may at least in part receive updates of current performance characteristics of portions of the memory blocks and/or information related to hardware associated with the logical server from a separate monitoring function.

In some embodiments, the MA updates memory grades, for example based on calculations, and stores the grades, e.g., in a memory grade table. The MA may thus provide dynamic sorting/grading of memory units, memory blocks, or portions thereof. The grading may then be conveniently used for obtaining performance characteristics of a portion of a memory block.

In further embodiments, the MA selects a suitable physical memory location for an application based on the memory grades. A memory grade may, e.g., comprise performance characteristics of a portion of a memory block allocated to a logical server.

In a particular embodiment, the first portion of the memory block is comprised in a first memory unit, and the second portion of the memory block is comprised in a second memory unit. The first memory unit and the second memory unit may be located in the same memory pool or in different memory pools. Alternatively, or additionally, the first memory unit and the second memory unit may comprise different types of memory, e.g., Solid-State Drive, SSD, Non-Volatile RAM, NVRAM, SDRAM, and flash type of memory.

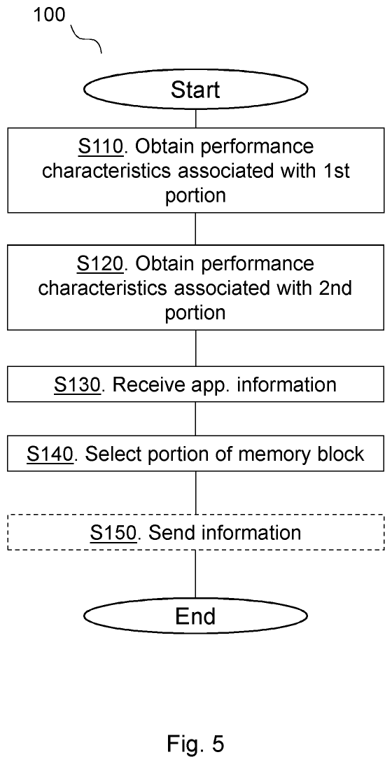

FIG. 5 is a flowchart depicting a method 100 performed by a MA according an embodiment herein for allocating memory to an application, during the application's initialization on a logical server, for example running in a data center. Such a data center normally comprises at least one memory pool. A memory block has been allocated to the logical server from at least one memory pool.

In S110 the MA obtains performance characteristics associated with a first portion of the memory block and obtains in S120 performance characteristics associated with a second portion of the memory block. As described earlier, the performance characteristics may be obtained, e.g., by the MA monitoring hardware associated with the logical server, or by receiving information relating to hardware associated with the logical server.

The method further comprises the MA receiving S130 information associated with the application. Such information may for example be one or more of a priority for the application, information on delay sensitivity for the application, information relating to frequency of memory access for the application, a memory request of the application.

The method further comprises selecting S140 one of the first portion and the second portion of the memory block for allocation of memory to the application, based on the received information and at least one of the performance characteristics associated with the first portion of the memory block and the performance characteristics associated with the second portion of the memory block.

In one embodiment of the method, the selecting S140 of one of the first portion and the second portion of the memory block for allocation of memory to the application, is based on the received information associated with the application, the performance characteristics associated with the first portion of the memory block and the performance characteristics associated with the second portion of the memory block.

In some embodiments of the method 100 the selecting S140 comprises comparing the information associated with the application with performance characteristics associated with the first portion and the second portion of the memory block. In this way the MA may, e.g., conclude that the first portion is more suitable for the particular requirements associated with the application. For example, the application may be sensitive to delays whereby the first portion best matches the need of the application. In another example, the application is not delay sensitive, nor requires frequent memory access, and the MA may therefore select the second portion of the memory block, which for example may have performance characteristics associated with a low grade, e.g., being located far from the CPUs and thus having long delay, having long access time, the memory unit comprising the portion having a low percentage of unused memory, etc.

In particular embodiments of the method 100 the information associated with the application comprises one or more of memory type requirements, memory volume requirements, application priority, and application delay sensitivity. Having such information, the MA may suitably match application requirement(s) to performance characteristics of a portion(s) of the memory block allocated to the logical server, enabling optimal use of available memory and/or fulfilling performance requirement of the application.

In a certain embodiment, the method 100 further comprises the MA sending S150 information relating to the selected S140 one of the first portion and the second portion of the memory block for enabling allocation of memory to the application. For example, sending S150 the information to a memory management entity.

According to this embodiment, the sending S150 may comprise initiating update of a memory management table, such as a MMC table or a MMU table. Additionally, or alternatively, the sending S150 may comprise informing the MMC of physical memory addresses associated with the selected S140 one of the first portion and the second portion of the memory block. In this way, the process is transparent from OS, as the OS will select an address range from its virtual addresses, without querying the MA first, and the selection and mapping is done by MA and MMC. Hence, the OS is not affected in this embodiment. Suitably, the information associated with the application received S130 by the MA comprises information relating to a memory space in the OS virtual memory, selected by the OS in response to an application memory request. This may enable the MA to perform a virtual to physical memory mapping, which may further be used for performing an update of the MMC memory mapping table.

Alternatively, the sending S150 may comprise informing an OS of virtual memory addresses, such as a virtual memory address range, associated with the selected S140 one of the first portion and the second portion of the memory block. Receiving such information enables the OS to select a memory space from the OS virtual memory to which to map the application virtual memory, such as for example received in a memory request from the application.

According to this alternative, no update of tables for virtual to physical memory mapping is required in the middle of the process, so it can be faster. However, the OS needs to send information associated with the application to the MA, and receive a response, before selecting the address range in the OS virtual memory. Hence, some modification of OS is needed.

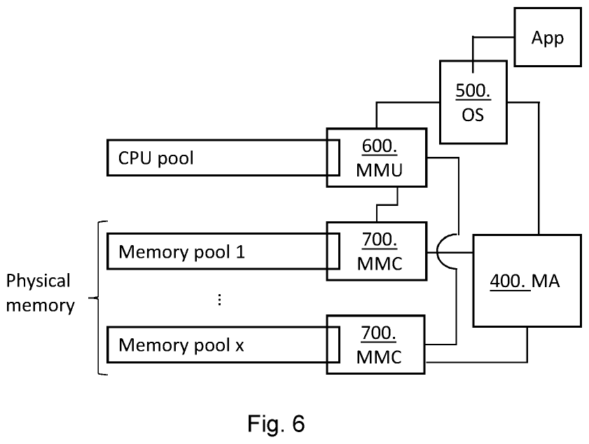

FIG. 6 illustrates schematically components of an arrangement according to an embodiment herein. According to this embodiment, there is provided a MA 400 for selecting a suitable portion of a memory block. The MA 400 may further be able to handle the mapping between physical and virtual memory. In some embodiments, the MA 400 is in contact with a first and a second MMC 700 which is responsible for managing memory units of memory pool 1 and memory pool 2, respectively, and the MA 400 also communicates with a logical server OS 500 to receive information associated with the application being initialized on the logical server, e.g., information relating to application requirements, such as application priority, required memory volume, delay sensitivity, etc. The OS 500 keeps the mapping between App virtual memory addresses and the OS virtual memory addresses. The OS 500 further communicates with a MMU 600, which may provide translations of a virtual memory address to a physical memory address, and the MMU is associated with the CPU (either by being implemented as part of the CPU, or as a separate circuit).

In a particular embodiment, the MA 400 keeps a table of available memory units, and allocated memory blocks, e.g. portions thereof, with their exact location and address. It monitors the access rate and occupancy percentage of each memory units, and updates grade of memory blocks based on the monitoring data, for example memory characteristics. Memory grades are used by the MA 400 to select suitable parts of physical memory based on the application requirements.

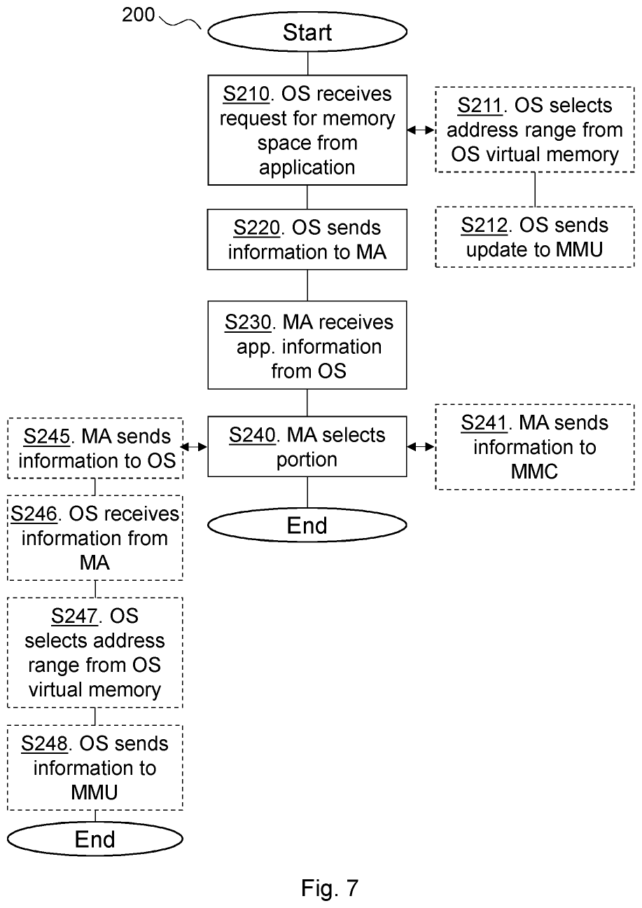

FIG. 7 is a flowchart depicting an embodiment of a method 200 performed by an arrangement for allocating memory to an application on a logical server, for example of a data center. The logical server has a memory block allocated from at least one memory pool. According to the method an OS 500 receives S210 a request for memory space from an application. The OS may further receive information relating requirements of the application, such as priority of the application, delay sensitivity, etc. The OS sends S220 information associated with the application, e.g., related to the requested memory space, application priority, application delay sensitivity, etc., to a MA 400. This information may optionally include the information relating to requirements of the application, received from the application. Also according to the method, the MA 400 receives S230 the information associated with the application from the OS 500 and selects S240 one of a first portion and a second portion of the memory block for allocation of memory to the application, based on information associated with the application and at least one of a performance characteristics associated with the first portion of the memory block and a performance characteristics associated with the second portion of the memory block.

The MA may thus before the selection S240, obtain performance characteristics associated with the first portion of the memory block and a performance characteristics associated with the second portion of the memory block, for instance by monitoring hardware of the logical server, e.g., memory units, CPU(s), communication links, etc. As an alternative, the MA 400 obtains said performance characteristics, at least portions thereof, from a separate function which monitors the hardware.

In one embodiment of the method 200, the OS 500 further selects S211 a memory address range from the OS virtual memory and sends S212 the information related to the selected memory address range to a MMU 600. This information may also be comprised in the information associated with the application sent S220 to the MA 400, and hence this information is received S230 by the MA 400. The MA 400 further sends S241 information relating to the selected S240 one of the first portion and the second portion of the memory block, e.g., in form of an update message related to the physical memory addresses associated with the selected S240 one of the first portion and the second portion of the memory block, to an MMC 700.

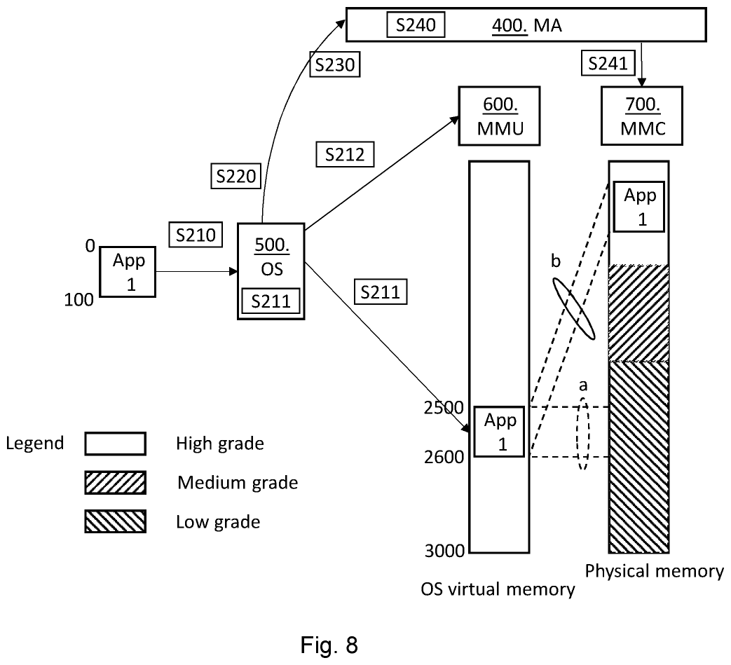

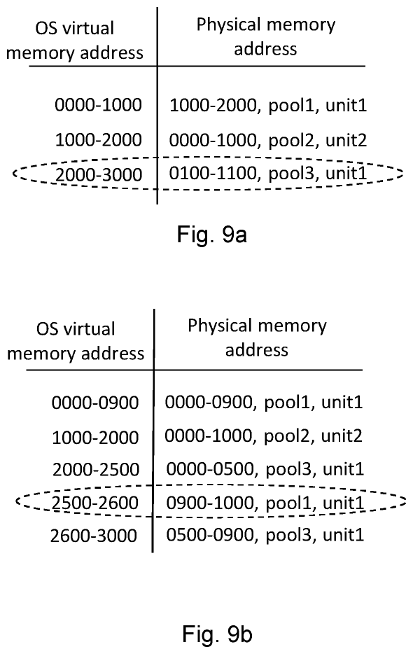

FIG. 8 illustrates schematically an exemplary arrangement for performing an exemplary method of this embodiment. As shown, the OS 500 selects S211 a memory space from the OS virtual memory and sends S212 an update to the MMU. The OS 500 further sends S220 information associated with the application, e.g. comprising a notification of the selected S211 memory space from the OS virtual memory and, e.g., the allocated OS virtual memory addresses, application requirements, e.g., the application priority, and/or, delay sensitivity, to the MA 400, as soon as it has selected the address range from the OS virtual memory. The MA 400 receives S230 the information and may then check the memory grades (based on memory characteristics), and tries to find the best match from the hierarchy of physical memory units related to a portion of the memory block to select S240 a suitable portion of the memory block. In practice this may comprise selecting a physical memory space. The MA 400 further sends S241 an update message relating to the selected portion of the memory block to the MMC 700, and may thereby inform the MMC of a physical memory addresses associated with the selected S240 one of the first portion and the second portion of the memory block, to transparently update the virtual to physical memory address mapping of the MMC 700. If for instance an application has a high priority, MA 400 tries to map selected virtual memory addresses to an address range in the physical memory with the highest grade, e.g., the mapping according to “b” in FIG. 8. In this example, MA 400 maps 2500-2600, i.e., the address range from OS virtual memory, to physical memory address 900-1000 of pool 1, unit 1, which is the closest memory to CPU pool with highest memory grade. The updated MMC table may then be as in FIG. 9b.

According to the known art, when an application sends a request to OS to allocate a part of memory, the OS normally looks for a part of the memory with the same size that the application requested. This may be selected from anywhere within the virtual memory address spaces, as the OS has no notion of different characteristics of the underlying physical memory units. There is also a predefined mapping of the virtual memory addresses and the physical addresses kept by MMCs, as exemplified by FIG. 9a. For example, the OS may select address 2500-2600 of OS virtual memory to be mapped to 0-100 of the application's memory address. Based on this mapping these addresses are mapped to physical memory address 0500-0600 of pool 3, unit 1, which is the farthest memory pool from the CPU pool. In the known art, as described above, the mapping will instead be e.g. according to “a” in FIG. 8, thus a low-grade memory is allocated in the physical memory for the application.

Returning to FIG. 7, in another embodiment of the method 200 the MA 400 further sends S241 information, e.g. in form of a query message, related to the selected S240 one of the first portion and the second portion of the memory block to the MMC 700. The sent S241 information may e.g. be physical memory addresses associated with the selected S240 portion of the memory block, and the MMC may respond with corresponding virtual memory addresses. The MA sends S245 information relating to the selected S240 one of the first portion and the second portion of the memory block to the OS 500, e.g., a message informing the OS 500 of virtual memory addresses associated with the selected S240 one of the first portion and the second portion of the memory block. The OS 500 further receives S246 the information relating to the selected S240 one of the first portion and the second portion of the memory block, e.g., a message comprising a range of virtual memory addresses, from the MA 400 and selects S247 a memory address range for the application from the OS virtual memory. The method further comprises that the OS 500 sends S248 the information related to the selected S247 memory address range from the OS virtual memory to the MMU 600.

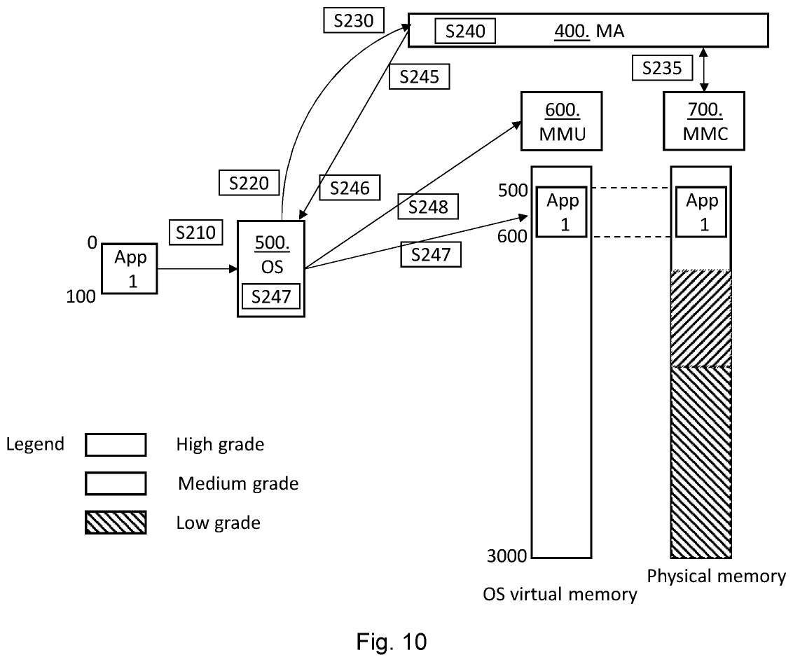

FIG. 10 illustrates schematically an exemplary arrangement for performing the method of this embodiment. When the application sends S210 the memory allocation request to the OS 500, the OS 500 sends S220 information associated with the application, which may comprise the requested memory space and additionally information relating to requirements of the application to the MA 400. The MA 400 receives S230 the information associated with the application from the OS 500 and selects S240 one of a first portion and a second portion of the memory block for allocation to the application, based on information associated with the application and at least one of a performance characteristics associated with the first portion of the memory block and a performance characteristics associated with the second portion of the memory block. The selected S240 portion is associated with a physical memory address range having a suitable memory grade to be allocated to the application. The MA 400 sends S241 information, e.g. in form of a query message to the MMC 700 querying the MMC table, to find the equivalent virtual memory address to that physical memory address range, and sends S245 information, e.g., the virtual memory address range to the OS 500, telling the OS 500 that it can only allocate memory to the application from this defined virtual memory address range. In this alternative, MMCs table, will not be altered by the MA decision. The OS 500 is then able to select S247 an address range from the OS virtual memory and sends S248 information, e.g. an update message to the MMU for updating the MMU table.

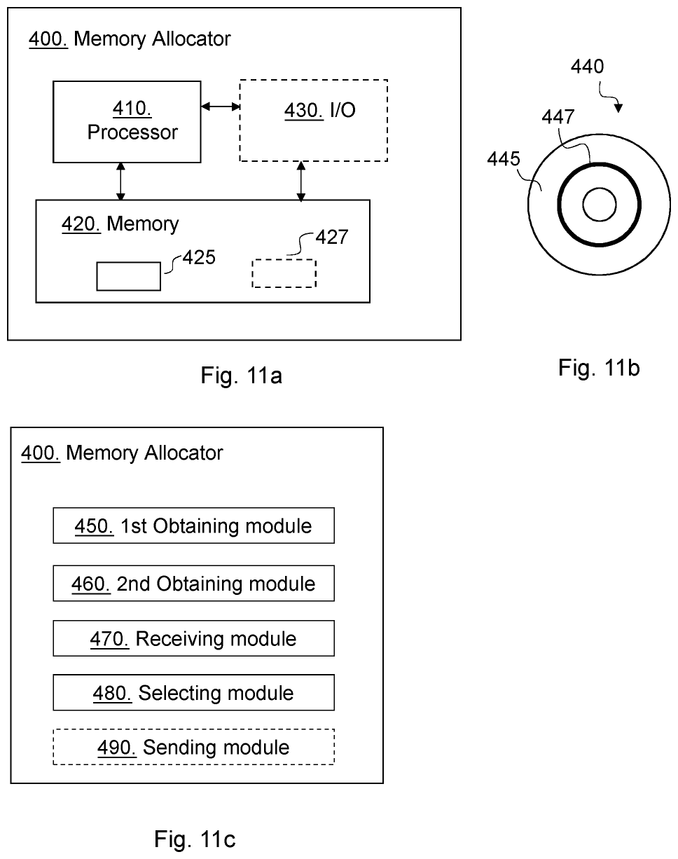

FIG. 11a is a schematic diagram illustrating an example of a computer implementation, in terms of functional units, the components of a MA 400 according to an embodiment. At least one processor 410 is provided using any combination of one or more of a suitable central processing unit (CPU), multiprocessor, microcontroller, digital signal processor (DSP), etc., capable of executing software instructions stored in a memory 420 comprised in the MA 400. The at least one processor 410 may further be provided as at least one application specific integrated circuit (ASIC), or field programmable gate array (FPGA).

Particularly, the at least one processor is configured to cause the MA to perform a set of operations, or actions, S110-S140, and in some embodiments also optional actions, as disclosed above. For example, the memory 420 may store the set of operations 425, and the at least one processor 410 may be configured to retrieve the set of operations 425 from the memory 420 to cause the MA 400 to perform the set of operations. The set of operations may be provided as a set of executable instructions. Thus the at least one processor 410 is thereby arranged to execute methods as herein disclosed.

The memory 420 may also comprise persistent storage 427, which, for example, can be any single one or combination of magnetic memory, optical memory, solid state memory or even remotely mounted memory.

The MA 400 may further comprise an input/output unit 430 for communications with resources, arrangements or entities of the data center. As such the input/output unit 430 may comprise one or more transmitters and receivers, comprising analogue and digital components.

The at least one processor 410 controls the general operation of the MA 400 e.g. by sending data and control signals to the input/output unit 430 and the memory 420, by receiving data and reports from the input/output unit 430, and by retrieving data and instructions from the memory 420. Other components, as well as the related functionality, of the MA 400 are omitted in order not to obscure the concepts presented herein.

In this particular example, at least some of the steps, functions, procedures, modules and/or blocks described herein are implemented in a computer program, which is loaded into the memory 420 for execution by processing circuitry including one or more processors 410. The memory 420 may comprise, such as contain or store, the computer program. The processor(s) 410 and memory 420 are interconnected to each other to enable normal software execution. An input/output unit 430 is also interconnected to the processor(s) 410 and/or the memory 420 to enable input and/or output of data and/or signals.

The term ‘processor’ should herein be interpreted in a general sense as any system or device capable of executing program code or computer program instructions to perform a particular processing, determining or computing task.

The processing circuitry does not have to be dedicated to only execute the above-described steps, functions, procedure and/or blocks, but may also execute other tasks.

FIG. 11b shows one example of a computer program product 440 comprising a computer readable storage medium 445, in particular a non-volatile medium. On this computer readable storage medium 445, a computer program 447 can be carried or stored. The computer program 447 can cause processing circuitry including at least one processor 410 and thereto operatively coupled entities and devices, such as the input/output device 430 and the memory 420, to execute methods according to some embodiments described herein. The computer program 447 and/or computer program product 440 may thus provide means for performing any actions of the MA 400 herein disclosed.

The flow diagram or diagrams presented herein may be regarded as a computer flow diagram or diagrams, when performed by one or more processors. A corresponding apparatus may be defined as a group of function modules, where each step performed by the processor 410 corresponds to a function module. In this case, the function modules are implemented as a computer program running on the processor 410.

The computer program residing in memory 420 may thus be organized as appropriate function modules configured to perform, when executed by the processor 410, at least part of the steps and/or tasks.

FIG. 11c is a schematic diagram illustrating, in terms of a number of functional modules, an example of an MA 400 for allocating memory to an application on a logical server having a memory block allocated in at least one memory pool. The MA 400 comprises:
a first obtaining module 450 for obtaining performance characteristics associated with a first portion of the memory block;
a second obtaining module 460 for obtaining performance characteristics associated with a second portion of the memory block;
a receiving module 470 receiving information associated with the application; and
a selecting module 480 for selecting one of the first portion and the second portion of the memory block for allocation of memory to the application, based on the received information and at least one of the performance characteristics associated with the first portion of the memory block and the performance characteristics associated with the second portion of the memory block.

The MA 400 may additionally comprise a sending module 490, for sending information relating to the selected one of the first portion and the second portion of the memory block for enabling allocation of memory to the application.

In general terms, each functional module 450-490 may be implemented in hardware or in software. Preferably, one or more or all functional modules 450-490 may be implemented by processing circuitry including at least one processor 410, possibly in cooperation with functional units 420 and/or 430. The processing circuitry may thus be arranged to fetch from the memory 420 instructions as provided by a functional module 450-490 and to execute these instructions, thereby performing any actions of the MA 400 as disclosed herein.

Alternatively it is possible to realize the module(s) in FIG. 11c predominantly by hardware modules, or alternatively by hardware, with suitable interconnections between relevant modules. Particular examples include one or more suitably configured processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending data and/or signals. The extent of software versus hardware is purely implementation selection.

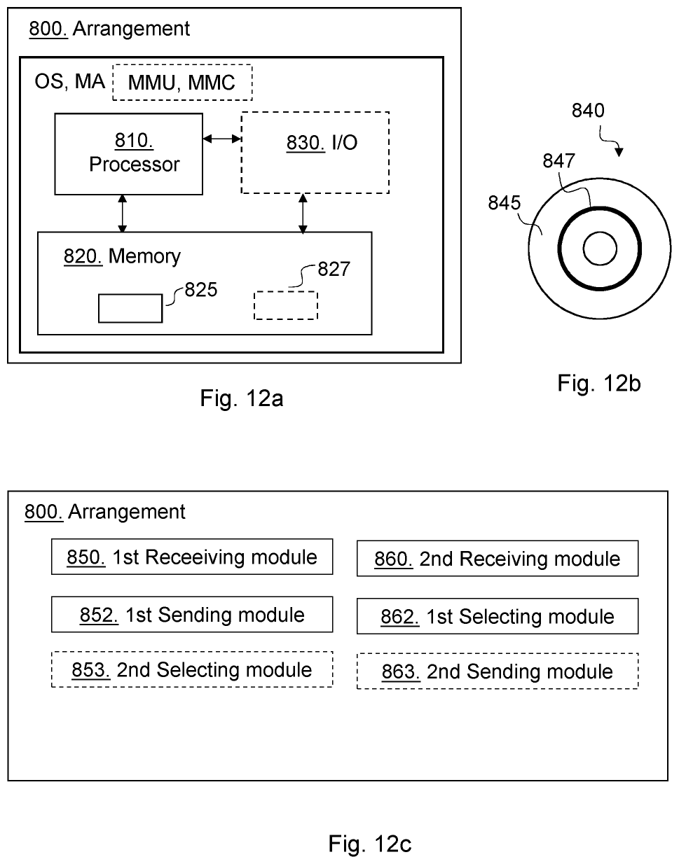

The components of the arrangement according to some embodiments herein, comprising a MA 400 and a logical server OS 500, and which additionally may comprise a MMU 600 and a MMC 700, may be realized by way of software, hardware, or a combination thereof. FIG. 12a illustrates schematically an arrangement 800 comprising at least one processor 810 is provided using any combination of one or more of a suitable central processing unit (CPU), multiprocessor, microcontroller, digital signal processor (DSP), etc., capable of executing software instructions stored in a memory 820. The at least one processor may further be provided as at least one application specific integrated circuit (ASIC), or field programmable gate array (FPGA).

Particularly, the at least one processor is configured to cause the arrangement to perform a set of operations, or actions, S210-S240, and in some embodiments also optional actions, as disclosed above. For example, the memory 820 may store the set of operations, and the at least one processor 810 may be configured to retrieve the set of operations 825 from the memory 820 to cause the arrangement 800 to perform the set of operations. The set of operations 825 may be provided as a set of executable instructions. Thus the at least one processor 810 is thereby arranged to execute methods as herein disclosed.

The memory 820 may also comprise persistent storage 827, which, for example, can be any single one or combination of magnetic memory, optical memory, solid state memory or even remotely mounted memory.

The arrangement 800 may further comprise an input/output unit 830 for communications with resources, other arrangements or entities of a data center. As such the input/output unit may comprise one or more transmitters and receivers, comprising analogue and digital components.

The at least one processor controls the general operation of the arrangement 800 e.g. by sending data and control signals to the input/output unit and the memory, by receiving data and reports from the input/output unit, and by retrieving data and instructions from the memory.

In this particular example, at least some of the steps, functions, procedures, modules and/or blocks described herein are implemented in a computer program, which is loaded into the memory 820 for execution by processing circuitry including one or more processors 810. The memory 820 may comprise, such as contain or store, the computer program. The processor(s) 810 and memory 820 are interconnected to each other to enable normal software execution. An input/output unit(s) 830 is also interconnected to the processor(s) 810 and/or the memory 820 to enable input and/or output of data and/or signals.

The term ‘processor’ should herein be interpreted in a general sense as any system or device capable of executing program code or computer program instructions to perform a particular processing, determining or computing task.

The processing circuitry does not have to be dedicated to only execute the above-described steps, functions, procedure and/or blocks, but may also execute other tasks.

FIG. 12b shows one example of a computer program product 840 comprising a computer readable storage medium 845, in particular a non-volatile medium. On this computer readable storage medium 845, a computer program 847 can be carried or stored. The computer program 847 can cause processing circuitry including at least one processor 810 and thereto operatively coupled entities and devices, such as the input/output device 830 and the memory 820, to execute methods according to some embodiments described herein. The computer program 847 and/or computer program product 840 may thus provide means for performing any actions of any of the arrangements 800 as herein disclosed.

The flow diagram or diagrams presented herein may be regarded as a computer flow diagram or diagrams, when performed by one or more processors. A corresponding apparatus may be defined as a group of function modules, where each step performed by the processor 810 corresponds to a function module. In this case, the function modules are implemented as a computer program running on the processor 810.

The computer program residing in memory 820 may thus be organized as appropriate function modules configured to perform, when executed by the processor 810, at least part of the steps and/or tasks.

FIG. 12c is a schematic diagram illustrating, in terms of a number of functional modules, an example of an arrangement 800 for allocating memory to an application on a logical server having a memory block allocated from at least one memory. The arrangement 800 comprises:
a first receiving module 850 for receiving at an Operating System, OS, a request for memory space from an application;
a first sending module 852 for sending from the OS, information associated with the application to a Memory Allocator, MA;
a second receiving module 860 for receiving at the MA, information associated with the application from the OS; and
a first selecting module 862 selecting one of a first portion and a second portion of the memory block for allocation of memory to the application, based on the information associated with the application and at least one of a performance characteristics associated with the first portion of the memory block and a performance characteristics associated with the second portion of the memory block.

In one embodiment, the arrangement 800 further comprises
a second selecting module 853 for selecting by the OS, a memory address range from an OS virtual memory;
and wherein the first sending module 852 is additionally for sending from the OS, the information related to the selected memory address range to a Memory Management Unit, MMU.

According to this embodiment, the arrangement further comprises
a second sending module 863 for sending from the MA, information relating to the selected one of the first portion and the second portion of the memory block to a Memory Management Controller, MMC.

In another embodiment of the arrangement 800, the second sending module 863 is additionally for sending from the MA, information related to the information associated with the application to a Memory Management Controller, MMC; and for sending from the MA, information relating to the selected one of the first portion and the second portion of the memory block to the OS.

Further according to this embodiment, the first receiving module 850 is additionally for receiving at the OS, the information relating to the selected portion of the memory block from the MA; and the second selecting module 853 is additionally for selecting by the OS, a memory address range from a OS virtual memory; and the first sending module 852 is additionally for sending from the OS, the information related to the selected memory address range to a Memory Management Unit, MMU.

In general terms, each functional module 850-863 may be implemented in hardware or in software. Preferably, one or more or all functional modules 850-863 may be implemented by processing circuitry including at least one processor 810, possibly in cooperation with functional units 820 and/or 830. The processing circuitry may thus be arranged to fetch from the memory 820 instructions as provided by a functional module 850-863 and to execute these instructions, thereby performing any actions of the arrangement 800 as disclosed herein.

Alternatively it is possible to realize the module(s) in FIG. 11c predominantly by hardware modules, or alternatively by hardware, with suitable interconnections between relevant modules. Particular examples include one or more suitably configured processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending data and/or signals. The extent of software versus hardware is purely implementation selection.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a memory allocator for allocating memory to an application on a logical server having a block of memory allocated from at least one memory pool, the method comprising:
obtaining performance characteristics associated with a first portion of the memory block;
obtaining performance characteristics associated with a second portion of the memory block;
receiving information associated with the application; and
selecting one of the first portion and the second portion of the memory block for allocation of memory to the application, based on the received information and at least one of the performance characteristics associated with the first portion of the memory block and the performance characteristics associated with the second portion of the memory block.

2. The method according to claim 1, wherein the selecting comprises comparing the information associated with the application with performance characteristics associated with the first portion and the second portion of the memory block.

3. The method according to claim 1, wherein the information associated with the application comprises one or more of memory type requirements, memory volume requirements, application priority, and application delay sensitivity.

4. The method according to claim 1, further comprising:
sending information relating to the selected one of the first portion and the second portion of the memory block for enabling allocation of memory to the application.

5. The method according to claim 4, wherein the sending comprises initiating update of a memory management table.

6. The method according to claim 4, wherein the sending comprises informing a Memory Management Controller of physical memory addresses associated with the selected one of the first portion and the second portion of the memory block.

7. The method according to claim 4, wherein the sending comprises informing an Operating System of virtual memory addresses associated with the selected one of the first portion and the second portion of the memory block.

8. A memory allocator for allocating memory to an application on a logical server having a memory block allocated from at least one memory pool, the memory allocator configured to:
obtain performance characteristics associated with a first portion of the memory block;
obtain performance characteristics associated with a second portion of the memory block;
receive information associated with the application; and
select one of the first portion and the second portion of the memory block for allocation of memory to the application, based on the received information and at least one of the performance characteristics associated with the first portion of the memory block and the performance characteristics associated with the second portion of the memory block.

9. The memory allocator according to claim 8, further configured to select one of the first portion and the second portion by comparing the information associated with the application with performance characteristics associated with the first portion and the second portion of the memory block.

10. The memory allocator according to 8 claim 8, wherein the information associated with the application comprises one or more of memory type requirements, memory volume requirements, application priority, and application delay sensitivity.

11. The memory allocator according to claim 8, wherein the memory allocator is further configured to:
send information relating to the selected one of the first portion and the second portion of the memory block for enabling allocation of memory to the application.

12. The memory allocator according to claim 11, wherein send information comprises initiating update of a memory management table.

13. The memory allocator according to claim 11, send information comprises informing a Memory Management Controller of physical memory addresses associated with the selected one of the first portion and the second portion of the memory block.

14. The memory allocator according to claim 11, wherein send information comprises informing an Operating System of virtual memory addresses associated with the selected one of the first portion and the second portion of the memory block.

15. (canceled)

16. A method for allocating memory to an application on a logical server having a memory block allocated from at least one memory pool, the method comprising:
receiving at an Operating System, OS, a request for memory space from an application;
sending from the OS, information associated with the application to a Memory Allocator, MA;
receiving at the MA, the information associated with the application from the OS; and
selecting by the MA, one of a first portion and a second portion of the memory block for allocation of memory to the application, based on the information associated with the application and at least one of a performance characteristics associated with the first portion of the memory block and a performance characteristics associated with the second portion of the memory block.

17. The method of claim 16, further comprising:
selecting (S211) by the OS, a memory address range from a OS virtual memory;
sending (S212) from the OS, the information related to the selected memory address range to a Memory Management Unit, MMU; and
sending from the MA, information relating to the selected one of the first portion and the second portion of the memory block to a Memory Management Controller, MMC.

18. The method of claim 16, further comprising:
sending from the MA, information related to the selected one of the first portion and the second portion of the memory block to a Memory Management Controller, MMC;
sending from the MA, information relating to the selected one of the first portion and the second portion of the memory block to the OS;
receiving at the OS, the information relating to the selected one of the first portion and the second portion of the memory block from the MA;
selecting by the OS, a memory address range from a OS virtual memory; and
sending from the OS, the information related to the selected memory address range to a Memory Management Unit, MMU.

19. (canceled)

20. (canceled)

21. (canceled)

22. A computer program comprising instructions, which when executed by at least one processor, cause the at least one processor to perform the corresponding method according to claim 1.

23. (canceled)

24. (canceled)
